(19) United States
(12) Patent Application Publication
(10) Pub. No.: US 2011/0035180 A1
(43) Pub. Date: Feb. 10, 2011

(54) DIAGNOSTIC APPARATUS AND SYSTEM ADAPTED TO DIAGNOSE OCCURRENCE OF COMMUNICATION ERROR

(75) Inventor: Noriyuki JIN, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/852,263

(22) Filed: Aug. 6, 2010

(30) Foreign Application Priority Data
Aug. 7, 2009 (JP) 2009-184771

(51) Int. Cl. G06F 19/00

(52) U.S. Cl. 702/122

(57) ABSTRACT

The diagnostic apparatus for diagnosing communication apparatuses connected thereto. The diagnostic apparatus periodically monitors a control data sent from the communication apparatuses and determines a communication apparatus to be diagnosed based on the monitoring result. The diagnostic apparatus is adapted to transmit a plurality of test signals to the communication apparatus to be diagnosed and the communication apparatus returns a response signal to the diagnostic apparatus as an acknowledge corresponding to the test signal. The diagnostic apparatus determines whether or not the response signal corresponding to the test signal is received within a predetermined period. The diagnostic apparatus diagnose whether or not a communication error occurs between the diagnostic apparatus and the communication apparatus based on the determining results.

### CROSS REFERENCE TO RELATED APPLICATION

This application is based on and claims the benefit of priority from earlier Japanese Patent Application No. 2009-184771 filed on Aug. 7, 2009, the description of which is incorporated herein by reference.

### BACKGROUND OF THE INVENTION

1. Field of the Invention

The present invention relates to a diagnostic apparatus and a diagnostic system, and more particularly to a diagnostic apparatus and a system for diagnosing a communication system in which a plurality of communication apparatuses are communicably connected with each other via a communication line.

2. Description of the Related Art

In recent years, a plurality of communication apparatuses is used in a vehicle system, which are arranged to be mutually communicable in the system. The communication apparatuses are required to have enhanced fail-safe functions to avoid unexpected accidents when the apparatuses are used in the vehicle systems. Hereinafter will be described existing techniques to enhance the fail-safe functions in the communication systems.

In the vehicle system, ECU (Electronic Control Unit) which controls the engine or the like is regarded as a communication apparatus. Also, CAN (Control Area Network) is often used in the vehicle system as a communication protocol used in the vehicle LAN (Local Area Network). Since two-wire communication line are used for the CAN communication, if a wire breakage occurs on one wire of the two communication line, the communication still can be done via the other wire of the communication line. However in such a case, the communication rate may be decreased causing unstable communication. Therefore, it is considered the communication apparatus sometimes fails to obtain the necessary communication rate.

When the wire breakage occurs on the communication line, if the communication apparatus detects the location of the wire breakage, the information about the location is used for countermeasure to the wire breakage. To detect the location of the wire breakage, following techniques are known. Specifically, Japanese Patent Laid-Open Publication Number 2003-304265 discloses how to identify the location of a wire breakage. According to the configuration disclosed in the patent document, terminators are connected to a communication bus. Conventionally, only ECUs connected to both ends of a communication bus have terminators. This configuration is required for the high-speed two-wire communication. In a configuration according to the patent document, additional terminators are used to detect the location of the wire breakage such that all ECUs have a terminator across the CAN lines, with a switch connected in parallel to the terminator. In the configuration, only the terminators connected to the ECUs of the end terminals are operated by closed switches when the wire breakage does not occur. Meanwhile, terminators connected to the ECUs disposed between ECUs of the end terminals are isolated by open switches. Therefore, while no wire breakage is detected, normal communication can be operated in this configuration. When the wire breakage occurs, respective ECUs control closing the switches sequentially in time and control the switches to be opened when the next ECU controls its switch to be closed. In other words, ECU having terminator to be activated is sequentially changed in turn. As a result, if there are no wire breakages in a section between the ECUs having switches temporarily closed, high-speed communication can be performed in the section between the ECUs. However, if there are wire breakages in the section between the ECUs having switches temporarily closed, the high-speed communication cannot be performed. Accordingly, the location of the wire breakage can be identified in this way, i.e., whether or not high speed communication can be performed in the section of the communication bus being diagnosed.

As described above, the wire breakage in the communication bus can be detected. However, wire breakage occurring at the line connected between the communication bus and the ECU cannot be detected. In this regard, Japanese Patent Laid-Open Publication Number 2007-329671 discloses a technique in order to detect a wire breakage, where a normal mode and a power-saving mode are switched by using a behavior of the voltage in a transient response because the behavior depends on whether or not the wire breakage exists.

Also, Japanese Patent Laid-Open Publication Number 2008-279947 discloses a technique to avoid a misjudgment when occurrence of the wire breakage needs to be determined by using a test signal. The misjudgment occurs under the following conditions. When the wire breakage occurred, an ECU affected by the wire breakage cannot determine the right of transmission (referred to transmission-right) correctly so that the ECU erroneously transmits the test signal without having the transmission right. In this case, the test signal collides with test signals transmitted by ECUs which are not affected by the wire breakage. As a result, ECUs which are not affected by the wire breakage cannot transmit test signals. Hence the ECUs are determined as being affected by the wire breakage.

Accordingly, when the ECU cannot complete transmitting the test signal, the ECU transmits another signal having high priority right than the test signal. As a result, the ECU can determine the cause of failing to transmit the test signal is not a wire breakage, but is the collision of the test signals.

Moreover, in the communication system using two-wire communication line, the following two techniques adapted to detecting the wire breakages are introduced. As the first technique, Japanese Patent Laid-Open Publication Number 1994-315176 discloses a technique adapted for telecommunication systems in which the wire breakage is detected without loss of sound quality. Specifically, a test signal for detecting the wire breakage is not outputted during the call. Hence, the test signal does not degrade the sound quality of the calling. Since a wire breakage could have occurred during the call and before the user hung up the phone, the test signal is outputted after the completion of the call thereby detecting wire breakage occurring during a call. This technique features the detecting the wire breakage being accomplished by using the user's behavior.

As the second technique, Japanese Patent Laid-Open Publication Number 1994-054033 discloses a technique in which the wire breakage is detected with a power saving. Specifically, while the messages are not transmitting, electric current among the communication apparatuses do not flow, and detecting the wire breakage is not performed. The wire breakage is detected by determining as to whether or not a reply message exists after a message is transmitted.

In the above-described techniques, it is considered the accuracy of the diagnostic test to detect failures is not high. With using the two wire communication line, the communication can be maintained even if a single wire is broken. However, a diagnostic test to detect failures might become complicated. In the above-described related arts, the diagnostic test is made by using a test signal in which the test signal is transmitted/received with a reference communication rate. That is, when the test signal is transmitted and received correctly with the reference communication rate, the communication line is normal and when the test signal is not transmitted and received correctly, a wire breakage is determined on the communication line. In this technique, even if a single communication line is broken, the communication can succeed with a communication rate exceeding the required rate. Therefore, although the communication line should be diagnosed as an abnormal state due to lack of the communication rate, the communication line is accidentally diagnosed as normal state. Also, when other communication channel such as one wire communication line is used in which the communication becomes unstable due to a reason (e.g. external disturbance) other than the wire breakage, the diagnostic test cannot easily detect these other problems using the above-described related art.

### SUMMARY OF THE INVENTION

The present invention has been made in light of above described issues. An object of the present invention is to provide a diagnostic apparatus and a system of which accuracy of the diagnostic test is enhanced.

To achieve the above-described object, as a first aspect of the present invention, a diagnostic apparatus being connected to a plurality of communication apparatuses via a communication bus, diagnosing at least one communication apparatus, the diagnostic apparatus including: monitoring means for monitoring a control data signal sent from the communication apparatuses at a predetermined period; first determining means for determining a communication apparatus to be diagnosed from among the plurality of communication apparatuses based on a result of the monitoring; transmitting means for transmitting a plurality of test signals to the communication apparatus to be diagnosed when the first determining means determines the communication apparatus, the test signals being uniquely recognizable each other; receiving means for receiving a response signal sent from the communication apparatus to be diagnosed, the response signal being recognizable as a signal responding to each test signal transmitted by the transmitting means; second determining means for determining whether or not the receiving means receives the response signal corresponding to each test signal within a predetermined period that limits an elapsed time counted from a time when the test signal is transmitted; and diagnosis means for diagnosing whether or not a communication error occurs between the diagnostic apparatus and the communication apparatus based on the determining results for respective response signals determined by the second determining means.

According to the first aspect of the present invention, the accuracy of the diagnostic test can be enhanced. Since the diagnostic apparatus is configured to transmit the test signal and determine whether or not the response signal responding to the test signal is received within the predetermined period of time, it is determined if the signals can travel as a round-trip between the diagnostic apparatus and the communication apparatus at which a communication error likely occur, within the predetermined period. Specifically, it is determined whether or not required communication rate between the diagnostic apparatus and the communication apparatus is ensured. As a result, the diagnostic apparatus can diagnose if the communication error occurs based on the above-described determination results. With this configuration, the diagnostic test can be made stably without any accidental factors that decrease accuracy of the diagnostic test whereby the accuracy of the diagnostic test can be enhanced. Regarding the determining results to be used for the diagnosing, entire determining results determined by the first and second determining means are not necessarily used. However, part of the determining results can be used. Also, the plurality of test signals can be transmitted sequentially in each test signal.

As a second aspect of the present invention, the diagnostic apparatus is configured to monitor the control data signal periodically sent from the communication apparatuses similarly to the diagnostic apparatus according to the first aspect of the present invention. In addition, the diagnostic apparatus according to the second aspect of the present invention includes a start signal transmitting means. The configuration of the diagnostic apparatus according to the second aspect of the present invention also solves the above-described issues.

The start signal transmitting means is configured to transmit a start signal to the communication apparatuses that periodically sends the control data signal when the communication apparatus to be diagnosed is detected. The start signal is used to notify the communication apparatuses about starting of a diagnostic test. When accept signals responding to the start signal are received by the diagnostic apparatus, a test signal transmitting means transmits a plurality of test signals to the communication apparatuses that send the accept signals. Further, the test signals can be uniquely recognizable from each other.

According to the second aspect of the present invention, the same advantage as the first aspect can be achieved. Further, the start signal is transmitted before transmitting of the test signals so that a communication apparatus in which a communication error likely occurs and other communication apparatuses are able to prepare for receiving the test signals. Specifically, transmission period of the control data signal can be extended or the transmission can be suspended before receiving the test signals. Since the other communication apparatuses in which no communication error is expected can be diagnosed by the diagnostic apparatus, possibility of detecting the communication errors can be increased.

Regarding the communication apparatuses that do not respond to the test signals at all, the diagnostic apparatus can immediately determine a communication error occurring on the communication apparatuses and may exclude the apparatuses from the object apparatuses to which the test signals are transmitted. As a result, the diagnostic apparatus does not need to transmit redundant test signals to the communication apparatuses in which the communication error likely occurs.

However, when the start signal is transmitted to the communication apparatuses only once in the above-described configuration, it is possible that some communication apparatuses happen to fail to receive the start signal or happen to fail to transmit the accept signal whereby the communication apparatuses are excluded from the object apparatuses to which the test signals are transmitted. However, these apparatuses are considered to be included in the object apparatuses and should be diagnosed by using the test signals.

In this case, to solve the problem, a third aspect of the present invention features a diagnostic apparatus in which the start signal is repeatedly transmitted. According to the third aspect of the present invention, since the communication apparatus is required to return the start signal at least once in response to the start signal which is repeatedly transmitted from the diagnostic apparatus, the communication apparatuses are not excluded from the object apparatuses to which the test signals are transmitted.

As described above, when the communication apparatus performs the preparation such as extending the transmission period of the control data signal before receiving the test signal, the communication apparatus may return the conditions i.e., transmission period or the like, when the diagnostic test is completed. Therefore, the communication apparatus is required to know the completion of the diagnostic test in order to resume the conditions. To solve the problem, the following configuration may be used in the present invention.

As a fourth aspect of the present invention, the diagnostic apparatus is adapted to transmit a termination signal notifying the completion of the diagnostic test to the communication apparatuses that receive the start signal.

According to the fourth aspect of the present invention, the diagnostic apparatus can notify the completion of the diagnostic test to the communication apparatuses thereby triggering the communication apparatuses to resume the communication condition. Specifically, conditions such as an extended transmission period or a suspended transmission state can be resumed.

It is considered that the load of the communication bus increases while the diagnostic apparatus transmits a plurality of test signals at the same time and while trying to receive the response signals responding to the test signals. In this case, to solve the problem, following configuration can be made. As a fifth aspect of the present invention, the diagnostic apparatus may be configured such that transmitting the test signal by the transmitting means and the determining the response signals by the second determining means are executed sequentially and alternately for every single test signal. Since the transmission of the test signal and the receiving/determining of the response signal are performed sequentially in time, a large amount of data is not transmitted at the same time. Therefore, the diagnostic test do not need to occupy the communication bus for a long time, the influence on the communication bus by the diagnostic test can be minimized. In other words, the diagnostic test can be done when the communication bus is quite busy.

In the above-described diagnostic apparatuses, it is considered that some of the determining results are not used for the diagnostic test. In such a case, some of the operations executed by the transmitting means and determining means are considered unnecessary. Also, the accuracy of the diagnostic test may decrease. To solve this problem following configuration can be used.

As a sixth aspect of the present invention, the diagnosis means is configured to use entire determining results of all response signals transmitted from the communication apparatuses when the diagnosis means diagnoses the communication error between the diagnostic apparatus and the communication apparatuses to which the test signals are transmitted. According to the sixth aspect of the present invention, operations of the transmitting means and the determining means are effectively used whereby the accuracy of the diagnostic test can be increased.

As a seventh aspect of the present invention, the diagnosis means is configured to diagnose the communication error based on a ratio represented by a frequency of failing to receive the response signals within the predetermined period, divided by a frequency of transmitting the test signals transmitted by the transmitting means.

According to a eighth and tenth to fifteenth aspect of the present invention, the above-described present invention can be adapted to a diagnostic system including the diagnostic apparatus. However, the diagnostic system according to the tenth and eleventh aspects of the present invention further includes extending means. The extending means is configured to extend a predetermined communication period used for transmitting the control data signal.

As a diagnostic system according to a ninth aspect of the present invention, the diagnostic apparatus includes an extending means which is similar to the extending means in the eleventh aspect of the present invention.

### BRIEF DESCRIPTION OF THE DRAWINGS

In the accompanying drawings:

FIG. 1 is a block diagram showing a communication system;

FIG. 2 is a flowchart showing a monitoring procedure;

FIG. 3 is a flowchart showing a first diagnostic procedure;

FIG. 4 is a flowchart showing a return-acknowledge procedure;

FIG. 5 is a timing chart showing a timing sequence for signals;

FIG. 6 is a flowchart showing a second diagnostic procedure;

FIG. 7 is a flowchart showing a start-response procedure;

FIG. 8 is a flowchart showing a termination procedure;

FIG. 9 is a flowchart showing a termination response procedure; and

FIG. 10 is a time chart showing a timing sequence for signals.

### DETAILED DESCRIPTION OF THE PREFERRED EMBODIMENTS

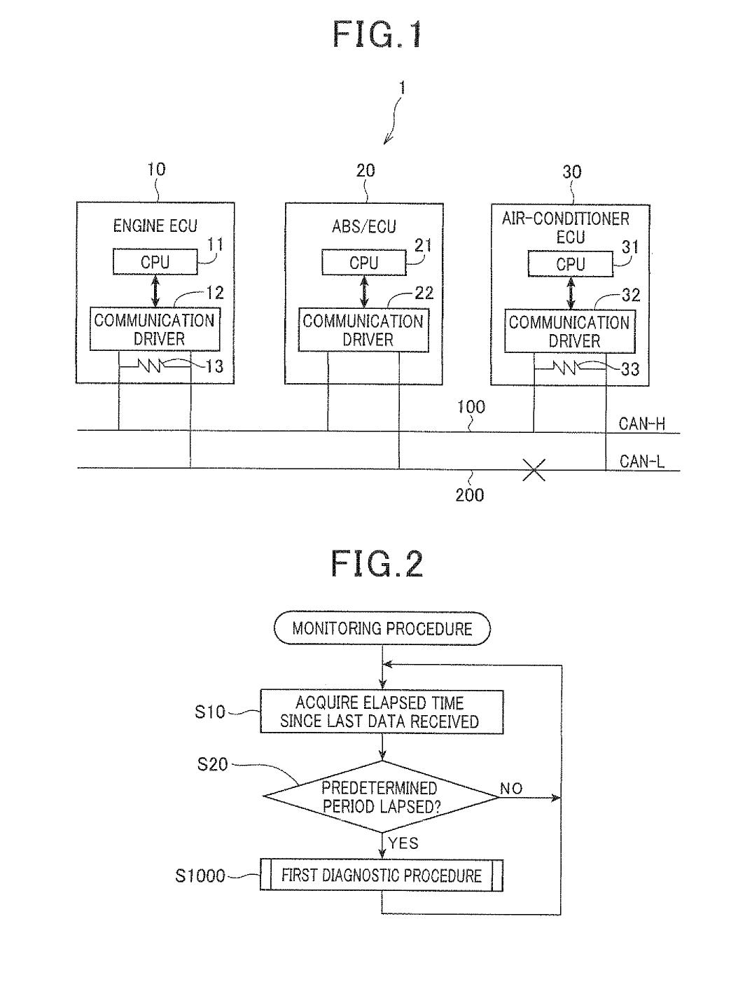

With reference to FIG. 1 to FIG. 5, hereinafter will be described a first embodiment of the present invention.

### First Embodiment

FIG. 1 illustrates a block diagram of a vehicle communication system 1 which is adapted to the present invention. The vehicle communication system 1 is mounted on the vehicle, and is provided with an engine ECU 10, an ABS ECU 20 and an air-conditioner ECU 30. The engine ECU 10, the ABS ECU 20 and the air-conditioner ECU 30 are ECUs (electronic control unit) each controlling the engine, the ABS and the air-conditioner of the vehicle respectively.

Further, each ECU includes a CPU, a communication driver and a memory unit. Specifically, as shown in FIG. 1, the engine ECU 10 includes a CPU 11 and a communication driver 12. The ABS ECU 20 includes a CPU 21 and a communication driver 22. The air-conditioner ECU 30 includes a CPU 31 and a communication driver 32. The memory unit is not shown.

The CPU is configured to perform a calculation based on signals sent by various sensor devices (not shown) or the other ECUs or the like, to control objects to be controlled (actuators for controlling engine or ABS unit or the like). Also the CPU is configured to send the calculation result to the objects as a command signal, or to send data to the other ECUs via the communication driver and a communication bus.

The communication driver serves as a communication control unit to control reception/transmission of data signal through the communication bus. Specifically, the communication driver is configured to control the output timing of data calculated by the CPU, to be outputted to the communication bus so as to transmit the CPU data to other ECUs. Also, the communication driver is configured to receive communication data intended for an ECU assigned to the driver and the communication driver, and to send the received data to the CPU.

In the vehicle communication system 1, the engine ECU 10 has a termination 13 and the air-conditioner ECU 30 has a termination 33. Since each ECU is connected to the communication bus i.e., CAN (Control Area Network) bus via the communication driver, the ECUs connected to the CAN bus can be mutually communicable via the two wired communication lines consisting of a CAN-H 100 and a CAN-L 200. The communication between ECUs is accomplished by the CAN protocol which is operated by the CPU and the communication driver. Generally, various ECUs more than three ECUs as shown in FIG. 1 are mounted on the vehicle system, which are configured to be mutually communicable by the CAN protocol. However, in the embodiment, to simplify the explanation, the vehicle communication system 1 including three ECUs is exemplified.

The engine ECU 10, the ABS ECU 20 and the air-conditioner ECU 30 correspond to the communication apparatuses in the present invention. The engine ECU 10 in the vehicle communication system 1 serves as a diagnostic apparatus that can detect a fault caused by possible communication errors. Specifically, the CPU and the communication driver of the ECU 10 serve as a function of the diagnostic apparatus. The engine ECU 10 as the diagnostic apparatus is operated based on a control data frame (control data signal) which is sent by the other ECUs i.e., ABS ECU 20 and air-conditioner ECU 30. The control data frame is periodically transmitted with a predetermined transmission period e.g. 10 msec. In addition to the periodical transmission, the control data frame may be transmitted on an event that requires the transmission.

FIG. 2 is a flowchart showing a monitoring procedure executed by the engine ECU 10 (specifically, executed by the CPU 11) as the diagnostic apparatus. This procedure is repeatedly executed in a normal operation in which each ECU transmits the control data frame periodically.

When the engine ECU 10 starts the monitoring procedure, then the engine ECU 10 acquires elapsed time from a time when the last control data frame was received (S10). Specifically, the engine ECU 10 acquires the elapsed time by using so-called free-running timer in which the count value is reset to ‘0’ every time the control data frame is received. Here, the number of frame types used for control data frames is equal to or more than the number of ECUs used for the communication. The elapsed time is measured for each type of the control data frames. Therefore, the free-running timers are arranged corresponding to each type of the control data frames and mutually different predetermined periods are set to the free-running timers.

Meanwhile, the monitoring procedure simultaneously operates plural procedures each corresponding to respective ECUs, as a parallel process. Specifically, the free-running timers are divided into groups corresponding to ECUs that send the control data frames being measured by the free-running timers. Each of the grouped timers is monitored by a monitoring procedure being assigned to each grouped timer. Also, the monitoring procedures assigned to individual grouped timers run individually. However, it is noted that the grouped free-running timer can be a single one.

At step 20 (S20), it is determined whether or not the predetermined period has elapsed (counted by a free-running timer). The free-running timer belongs to any one of the grouped timers to be monitored. When it is determined there are no free-running timer in which time counted by the timer has reached the predetermined period (S20, NO), the engine ECU 10 returns to step 10 (S10). On the other hand, when it is determined even if at least one free-running timer of which counted time has reached the predetermined period (S20, YES), the engine ECU 10 executes the first diagnostic procedure (S1000). Here, it is described regarding the above-described predetermined period. The first diagnostic procedure will be described later.

The predetermined period is set such that the period is set longer than the period of the control data frame. Meanwhile, to ensure detecting a failure such as degrading an emission of the engine that causes a violation of the law, the predetermined period is set so as to detect the failure at a time just before the failure occurs. For instance, when the control frames can not be received for four consecutive periods of time, which is considered that the failure occurs, three periods of time is set as the predetermined period e.g. when the period of the control frame is 10 msec, the predetermined period is 30 msec. Therefore, the first diagnostic procedure which is described later can be initiated just before the failure occurs.

As described above, such a unstable communication likely occurs caused by the wire breakage in the two wire communication lines as described in the related art. Specifically, as shown in FIG. 1, assuming a wire breakage occurred between the ABS ECU 20 and the air-conditioner ECU 30 on the CAN-L line 200, however, the CAN-H line 100 serves as an alternative communication line so that the communication can be partially performed. In such a condition, when the engine ECU receives the control data frames from other ECUs, the intervals of receiving the control data frames become longer or irregular. Hence, as described above, it takes a period three times longer than that of the regular period for receiving the control data frames.

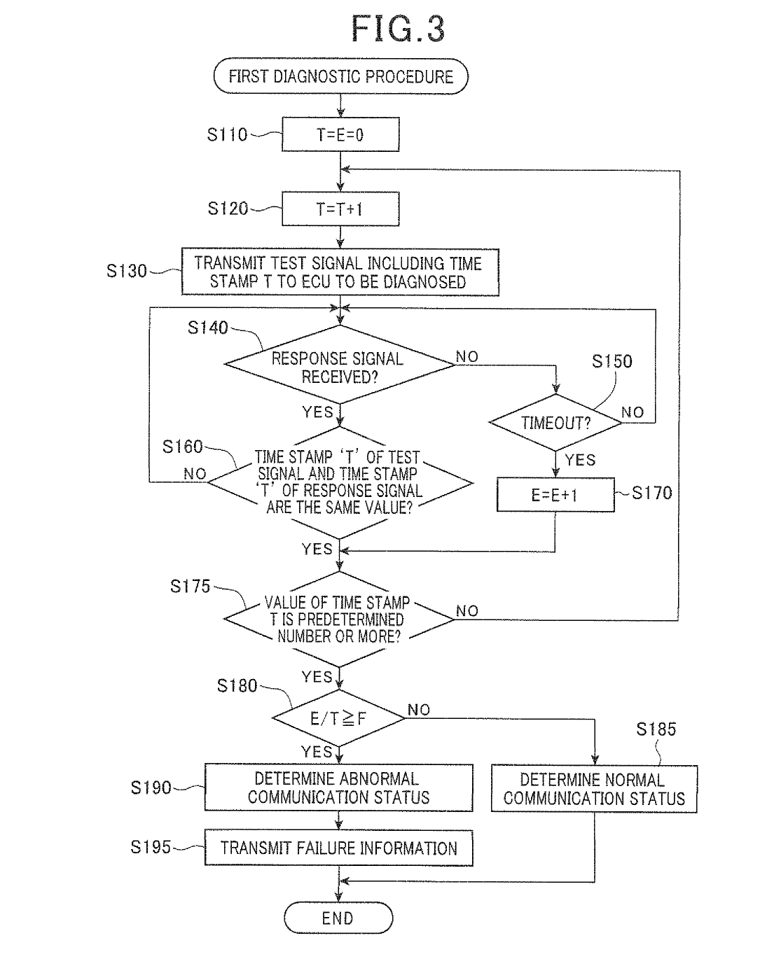

Hereinafter will be described the first diagnostic procedure. FIG. 3 is a flowchart showing the first diagnostic procedure. As described above, the engine ECU 10 as the diagnostic apparatus executes the first diagnostic procedure and the first diagnostic procedure is triggered when the counting time of the free-running timer reaches the predetermined period. The apparatus to be diagnosed is the ECU from which the communication data frame has not been received for a predetermined period of time.

The ECU 10 resets a time stamp T and an error counter E and sets the initial value ‘0’ respectively at S110. The usage of these variables is described later. Next, the ECU 10 increments the time stamp T by one (S120) and transmits a test signal including the time stamp T to the ECU being diagnosed (S130). This test signal can be identified by ID information included in the frame such that the test signal is identified as signal being used as a test signal and identified as a frame being sent to an ECU to be diagnosed. Further, the value of the time stamp E can be identified from reading the data field.

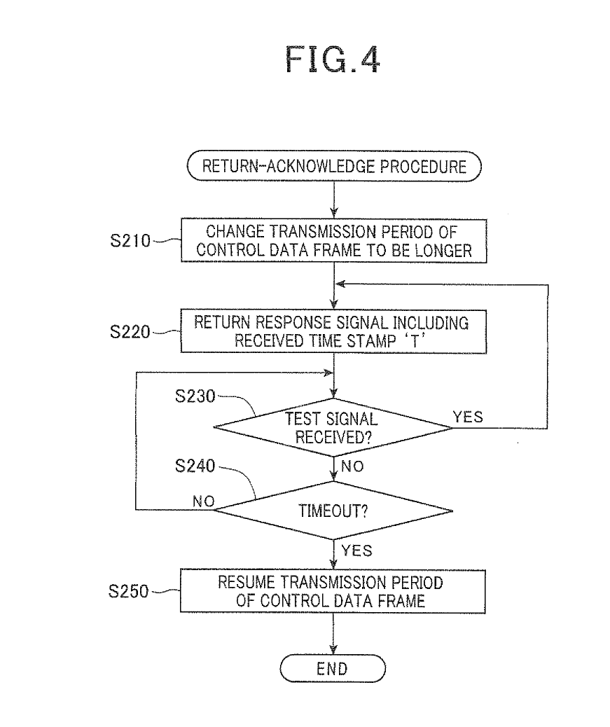

With reference to FIG. 4, a return-acknowledge procedure is described. The return-acknowledge procedure is executed by a CPU disposed in a ECU (e.g. ABS/ECU 20 or air conditioner ECU 30) other than the engine ECU 10. The return-acknowledge procedure is triggered by receiving the test signal. Specifically, based on the ID information, the CPUs included in the ABS/ECU 20 and the air-conditioner ECU 30 identify whether the received data is the control data frame or the test signal. The procedure identifying the received data is performed in a regularly executed procedure for receiving the control data frame. When the CPU identifies the test signal, the CPU suspends the regularly executed procedure, and proceeds to the return-acknowledge procedure.

When the ECU receiving the test signal (i.e., ECU being diagnosed) starts the return-acknowledge procedure, the ECU changes the transmission period of the control data frame to be longer (S210). The purpose of the change is to reduce the load on the communication bus thereby securing the time to use the communication line. The amount of change of the transmission period is determined in advance for respective ECUs. For instance, for safety-related ECUs such as the ABS/ECU 20, since the ECU requires relatively fast response times, the period of the transmission frame is not increased so much or not increased at all. In contrast, as to ECUs such as air-conditioner ECU 30, since the ECU does not cause any serious problems even if the control temporarily becomes insufficient, the period of the transmission frame can be increased. The purpose of increasing the transmission period is to reduce the load on the communication bus for the transmission of the test signal and a response signal which is described later. In such a way, a regular control using the control data frames transmission/reception and the communication procedure dedicated to the diagnostic control can be operated simultaneously whereby the diagnostic can be performed while the vehicle is running. Hence, failures occurring in the vehicle can be detected earlier so that a fail-safe function can be enhanced compared to the prior art.

At step S220, the response signal including the received time stamp T is sent back to the engine ECU 10 as a return-acknowledge. The response signal can be identified by the ID information such that the response signal is identified as a return-acknowledge to the test signal and identified as a frame being sent to the engine ECU 10. Moreover, a value of the time stamp T is contained in the data field.

As shown in FIG. 3, the engine ECU 10 determines whether or not the response signal from the ECU to be diagnosed has been received (S140). When the ECU 10 has not received the response signal (S140 NO), the ECU 10 checks at step S150 whether or not a timeout event occurred, time being counted from the time of S130. When the timeout does not occur (S150 NO), the engine ECU 10 returns to S140. When the engine ECU 10 receives the response signal (S140 YES), it is determined whether or not the time stamp T included in the test signal which is sent at S130 and the time stamp T included in the received response signal are the same value (S160). When both time stamps T are not the same value (S160 NO), the engine ECU 10 returns to S140. When it is determined the timeout occurred (S150 YES), the error counter E is incremented by one (S170) and proceeds to S175. Further, even when it is determined the time stamps are the same value (S160 YES), proceeds to S175 (the error counter E is not changed).

At S175, it is determined whether or not the time stamp T which is calculated at S120 is equal to a predetermined number or more (S175). The predetermined number is the number of retries for repeatedly sending the test signal and is used as a denominator for calculating a success ratio of the communication. For instance, assuming the acceptable success ratio of the communication is 30%, i.e., 3/10 or 30/100, a success ratio of the 30/100 is considered to be more reliable than 3/10 because the predetermined number for the communication count is larger. However, it is preferable to use a smaller number of communication count to ensure fast response of the diagnostic test. Therefore, the predetermined number is selected considering a balance of the reliability and the speed of response for the diagnostic test. When the time stamp T is less than the predetermined number (S175 NO), the ECU 10 returns to S120.

As shown in FIG. 4, the ECU being diagnosed returns the response signal (S220) and then, determines whether or not the test signal has been received (S230). When the test signal is not received (S230 NO), the ECU being diagnosed determines whether or not the timeout event occur (S240). The counted time is counted from the time when the previous (right before) test signal received. Specifically, in the return-acknowledge procedure of the respective ECUs, the free-running timer is reset every time when the test signal received and the timer starts to count again. The purpose of the procedure is to have the transmission period of the control data frames to be resumed (to proceed to S250) when the transmitting of the test signals by the engine ECU 10 is completed. It is possible to proceed to S250 right after the last test signal (i.e., the test signal of which time stamp T is identical to the predetermined number) is received. However, since the last signal can not be received when a fault occurs on the communication bus, in such a case, it is considered that a timeout period S240 is set as a fixed value using a maximum time necessary for transmitting all the test signals corresponding to the predetermined number. In this case, time required to reach the timeout is too long so that resuming regular communication (not in a diagnostic mode) is delayed.

In the vehicle communication system 1 according to the embodiment, following period is adapted as the timeout period of S240. The timeout period is estimated as a period between when the ECU being diagnosed received the last test signal and when the engine ECU 10 transmitted the last signal. The timeout period is defined using the time stamp T included in the last test signal that the ECU being diagnosed received, and a maximum value of the transmission interval of the test signal performed in the first diagnostic procedure. Therefore, the timeout period T-timeout can be expressed as:

T−timeout=(predetermined number of time stamp T−time stamp T of the last received test signal)×timeout period at S150+α(margin time for possible errors) (1)

A variable ‘time stamp T of the last received test signal’ is only used in this equation. The variable is decremented when each test signal is received. When the timeout is determined based on the above equation (1), after the timeout occurs, since the step already proceeded to S175 with a judgment YES in the first diagnostic procedure, transmission of the test signals by the engine ECU 10 may be completed. Hence, the ECU being diagnosed can go to S250 immediately after the last test signal is received. As to the timeout period, for example, assuming ‘the predetermined number of time stamp T’=10 and ‘the time stamp T of the last received test signal’=5, the timeout period of step S240 will be ‘5×the timeout period at S150+α’. Also, if it is ‘the predetermined number of time stamp T’=‘the time stamp T of the last received test signal’=10, the timeout period of step S240 will be ‘α’.

When the timeout has not occurred (S240 NO), the ECU returns to S230. When the test signal has received (S230 YES), the ECU returns to S220 and when the timeout has occurred (S240 YES), the transmission period of the control data frame is resumed (S250) then the ECU being diagnosed terminates the procedure.

Regarding the transmission and reception for the test signal and the response signal as described above, if the communication is unstable, communication of the transmission and the reception of the signals may be incomplete. The communication may fail due to the timeout when the communication rate is becoming slower whereby period between a time of transmitting the test signal and a time of the reception of the response signal becomes longer. Also, the ECU being diagnosed does not execute the return-acknowledge procedure if the test signal never reaches the ECU. In this case, the engine ECU cannot receive the response signal at all.

As shown in FIG. 3, when the engine ECU 10 determines the time stamp T is the predetermined number or more (S175 YES), the engine ECU 10 determines whether or not E/T (a value of the error counter E divided by the time stamp T, i.e., a value indicating the ratio of the communication errors) is the threshold value F (a threshold value of the communication errors) or more (S180). The threshold value F is set for respective ECUs based on the importance of the functions that the respective ECUs own. Specifically, for the ABS/ECU 20 concerning the safety operations, a stricter threshold may be set (e.g. 50%). In contrast, as to other ECUs, e.g. the air-conditioner ECU 30, a more relaxed threshold can be set (e.g. 70%).

At S180, when the E/T is less than the threshold value F (S180 NO), it is judged that the communication status of the ECU being diagnosed is in normal condition (S185) and terminates the procedure. When the E/T is equal to or more than the threshold value F (S180 YES), it is judged that the communication status of the ECU is in abnormal condition (S190). Then, at S195, the ECU 10 transmits the failure information (information about the abnormal communication status) to communication devices concerning the ECU that is diagnosed as in an abnormal communication status (including devices which is not shown) and terminates the procedure.

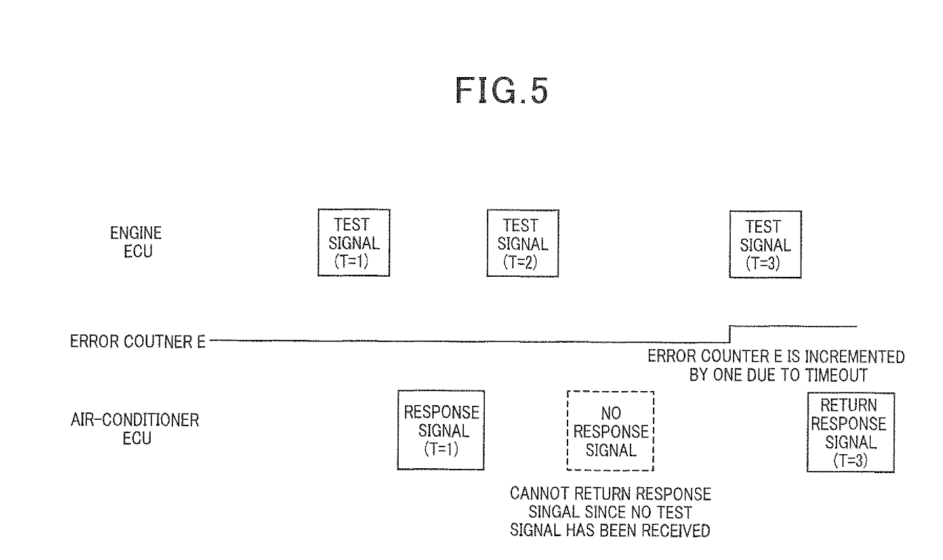

FIG. 5 illustrates the timing chart showing a timing sequence for signals in which the first diagnostic procedure and the return-acknowledge procedure by the air-conditioner ECU 30 are performed. As shown in FIG. 5, when the time stamp T=1 or T=3, the communication i.e., the reception and the transmission for the test signal and the response signal was successful. However, when the time stamp T=2, since the air-conditioner ECU 30 fails to receive the test signal, the response signal is not transmitted to the engine ECU 10 thereby failing the communication. Therefore, the error counter E is incremented by one after the timeout occurred with the time stamp T=2. In this case, the value of the E/T is ⅓ when the predetermined number of the time stamp is three. The value of the E/T, ⅓ is set during the diagnostic procedure.

Here, advantages of the first embodiment are described as follows. In the vehicle communication system 1 according to the first embodiment, it is judged whether or not the communication has succeeded within a predetermined period in which the transmitting the test signal and the reception of the response signal corresponding to the test signal transmitted right before the response signal should be completed. In other words, it is judged multiple times whether or not the signal travels between ECUs within the predetermined period. Hence, the diagnostic test can be performed with high accuracy. It is noted ‘judging whether or not the signal travels between ECUs’ indicates whether or not the communication satisfies the required communication rate. As described, when the judging is made multiple times, accuracy of the diagnostic result can be enhanced compared to the conventional system. Specifically, since it is possible for the communication to succeed even when the communication line state is an abnormal condition, the judgment may be made erroneously with only one judgment. However, by the multiple judgments, such an accidental judgment of the diagnostic result can be suppressed.

In particular, high accuracy of the diagnostic test is required for the engine control that is controlled by the engine ECU 10. In fact, since the engine control has a purpose of controlling the emission of the engine, if the engine ECU 10 cannot detect the abnormal condition of the communication line, it is possible that the engine ECU 10 cannot detect an event that causes deterioration of the emission. The reason why the deterioration of the emission likely occurs is that the engine is controlled by using the control data frames which are transmitted/received between the engine ECU 10 and the other ECUs (such as air-conditioner ECU 30 etc), and the format of the control data frame includes a pair of logically related frames which should be handled together during the engine control. In the vehicle communication system 1, a fault diagnostic test is performed based on whether or not such a condition i.e., to maintain the frame format, is satisfied. Hence, the diagnostic test in the vehicle communication system 1 can detect accurately such an event causing the deterioration of the emission.

### Second Embodiment

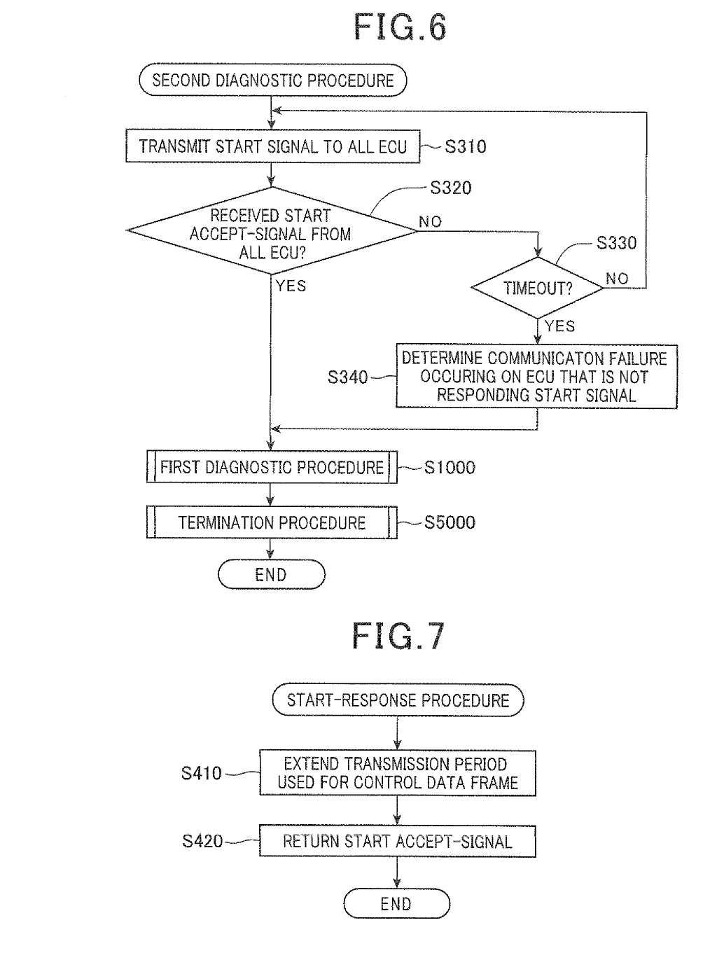

With reference to FIG. 6 to FIG. 10, hereinafter will be described a second embodiment of the present invention. As to the second embodiment, only a portion that differs from the first embodiment is described. In the second embodiment, in addition to the first diagnostic procedure, the engine ECU 10 executes a second diagnostic procedure (specifically, the second diagnostic procedure is initiated when the judgment at the S20 is YES in the monitoring procedure as shown in FIG. 2). Also, in addition to the return-acknowledge procedure, the ABS/ECU 20 and the air-conditioner ECU 30 execute a start-response procedure and a termination response procedure. Note: in the second embodiment, the first diagnostic procedure and the return-acknowledge procedure are slightly modified from the procedure in the first embodiment (described later).

As shown in FIG. 6, the second diagnostic procedure executed by the engine ECU 10 is illustrated. The engine ECU 10 transmits a start signal to other ECUs (ABS/ECU 20 and air-conditioner ECU 30) at step S310 when the second diagnostic procedure is started. The start signal is sent before sending the test signal and used as a signal to notify sending the test signal. The start signal does not include the time stamp T. Also, the signal is identified as the start signal by the ID information included in the frame and identified as a signal sending to all ECUs that are connected to the same communication line. Moreover, the start signal can be distinguished from the control data frame.

Next, with reference to FIG. 7, a start-response procedure is described. As shown in FIG. 7, the flowchart illustrates the start-response procedure executed by the ABS/ECU 20 and the air-conditioner ECU 30. This procedure is triggered by receiving the start signal. Receiving the start signal, the ECU starts the start-response procedure, and the ECU extends the transmission period of the control data frame (S410). In other words, the ECU operates the same procedure as the return-acknowledge procedure executed at S210 of the first embodiment. Then, the ECU returns a start accept-signal to the engine ECU 10 (S420) and terminates the procedure. The start accept signal can be identified as an acknowledge signal of the start signal and also identified as a signal transmitted to the engine ECU 10, by the ID information included in the frame. Therefore, the start accept-signal is differentiated from the control data frame.

As shown in FIG. 6, the engine ECU 10 determines whether or not the start accept-signal has been transmitted by each of other ECUs for at least one time (S320). When the ECU 10 detects an ECU that has not responded to the start accept-signals, the ECU 10 judges the whether or not the timeout has occurred (S330). The timeout is counted from at a time when the second diagnostic procedure was initiated. Specifically, the ECU 10 resets the free-running timer when the second diagnostic procedure is initiated and the ECU 10 judges if the timeout event occurs based on whether or not the start accept-signals being transmitted by the other ECUs, have been received within the predetermined period elapsed.

When the ECU 10 determines the timeout does not occur (5330 NO), the ECU 10 returns to S310 and transmits the start signal. Therefore, if the normal communication (transmission and reception) is performed, the start-response procedure is repeatedly executed every time when the judgment at S330 is NO.

Meanwhile, when the timeout is detected at S330 (S330 YES), the ECU 10 determines that a communication error has occurred on the ECU which is not responding with the return-acknowledge (S340), executes the first diagnostic procedure described in the first embodiment (S1000). Also, even when the start accept-signal is received at least one time from respective other ECUs (S320 YES), the ECU 10 executes the first diagnostic procedure (S1000).

According to the second embodiment, in the first diagnostic procedure, the ECU 10 sends the test signals to all ECUs that return the start accept-signals. Therefore, the ECU 10 performs the first diagnostic procedure not only for the ECUs being unstable in the communication but also the other ECUs at the same time. As a result, the probability of detecting communication errors can be enhanced. Also, since all ECUs receiving the start signals can extend the transmission period used for the control data frame (at S410 operation), the load on the communication bus can be easily reduced. As a result, available time for transmission of the test signals on the communication bus can readily be secured (In the first embodiment, only the ECUs being diagnosed needs to operate for securing the time of communication bus. Hence, the system in the second embodiment can provide large flexibility of designing the system, compared to the first embodiment). Meanwhile, the ECU receiving the test signal in the first diagnostic procedure, executes the return-acknowledge procedure as described in the first embodiment. However, the ECU 10 does not execute Steps S210 and S250 because these steps are executed by the start-response procedure or the termination response procedure (refer to FIG. 9). The other steps are performed similar to the steps in the return-acknowledge procedure of the first embodiment.

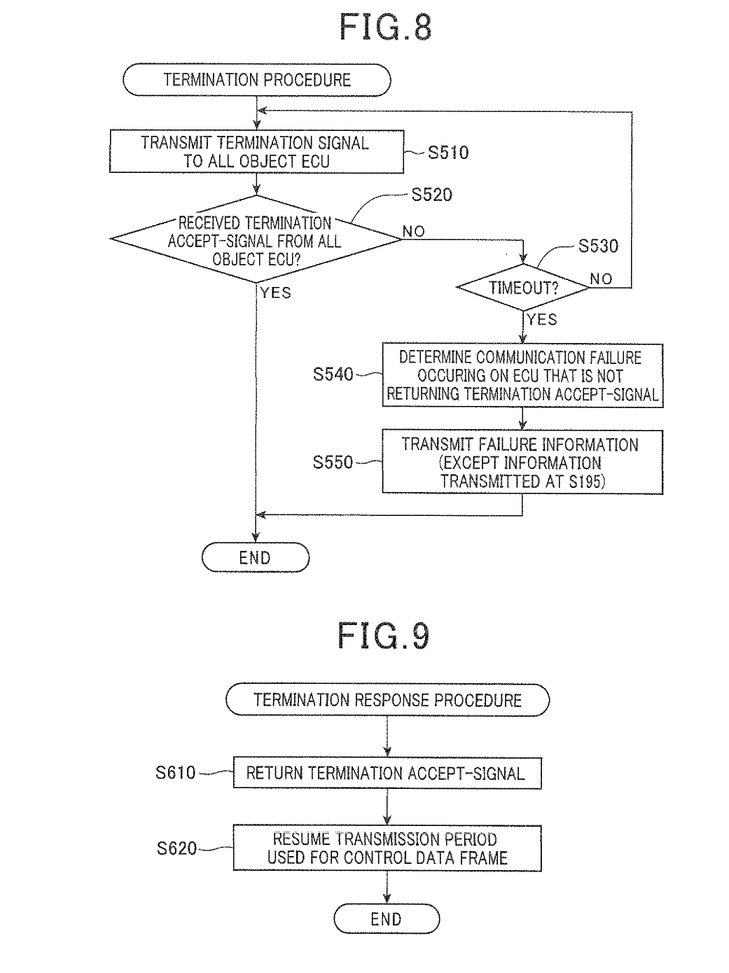

The engine ECU 10 executes a termination procedure when the first diagnostic procedure for the whole object ECUs is completed (S5000). FIG. 8 illustrates a flowchart showing the termination procedure. As shown in FIG. 8, when the engine ECU 10 starts the termination procedure, the ECU 10 transmits a termination signal to all object ECUs diagnosed in the first diagnostic procedure (S510). The termination signal is to indicate the termination of transmitting the test signals.

FIG. 9 is a flowchart showing the termination response procedure executed by the ABS/ECU 20 and the air-conditioner ECU 30. In the termination response procedure, the termination signal triggers the procedure. When the ECU that receives the termination signal initiates the termination response procedure, the ECU returns a termination accept-signal to the engine ECU 10 (S610). The termination accept-signal can be identified by the ID information included in the frame, identified as an acknowledge signal of the termination signal and a signal transmitted to the engine ECU 10 whereby the termination accept-signal is distinguished from the control data frames. Subsequently, the ECU changes the transmission period of the control frame to the original value (S620) i.e., the same procedure as the return acknowledge at S250 of the first embodiment, and terminates the procedure.

Referring to FIG. 8, the engine ECU 10 determines whether or not the termination accept-signal has been received at least once from the respective ECUs to which the termination signals was transmitted (S520). When the termination accept-signal has not been received (S520 NO), the engine ECU 10 determines whether or not the timeout has occurred (S530). The timeout is determined based on a period counted from a time when the termination procedure was started. Also, the timeout can be determined by using the free-running timer as described above.

When the ECU 10 determines the timeout does not occur (S530 NO), the ECU 10 returns to S510 and transmits the termination signal. Therefore, while the communication is successfully performed, the termination response procedure is performed every time when the judgment of S530 is NO.

When the ECU 10 receives the termination accept-signal at least once from the respective ECUs that receive the termination signal (S520 YES), the ECU 10 terminates the procedure. When the ECU 10 determines the timeout has occurred (S530 YES), the ECU 10 determines the communication error about the ECUs that do not return the termination accept-signal (S540). Specifically, the determination of the communication error about the ECUs can be opposite from a result of the first diagnostic procedure showing the communication status is normal (S185). However, since the result showing the normal communication is determined based on a communication error ratio which is less than a threshold value, it is considered that determination of the communication error at S540 is rare. In this regard, the ECU 10 performs this diagnostic operation, in addition to the procedure for adjusting the load of the communication bus under the diagnostic operation in which the start/termination signals are received and transmitted. Then, the ECU 10 transmits failure information about the ECUs (S550) which is determined as the opposite result from the first diagnostic procedure (i.e., excluding ECUs transmitted the failure information at S195) and terminates the procedure.

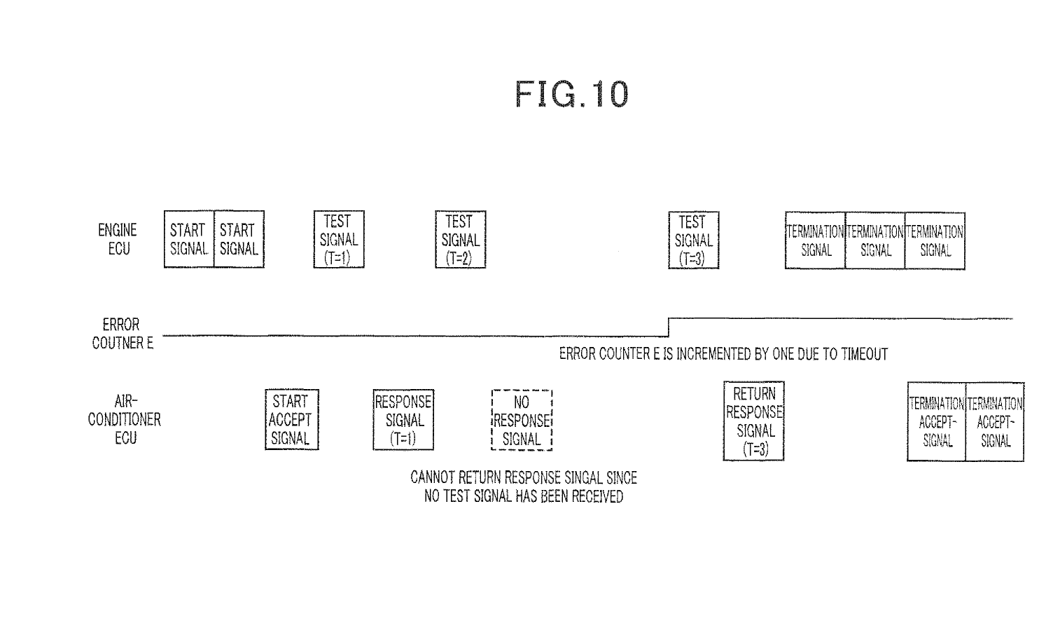

FIG. 10 is a time chart showing a timing sequence for signals according to the second embodiment. As shown in FIG. 10, a time chart in which signals are transmitted between the engine ECU 10 and the air-conditioner ECU 30 is illustrated. The start signal is transmitted by the ECU 10 and the start accept-signal is transmitted to the engine ECU 10 from the air-conditioner ECU 30 as an acknowledge signal and the termination signal and the termination accept-signal are transmitted and received between both ECUs. Similarly, the test signal and the response signal are transmitted/received between both ECUs. As shown in FIG. 10, the start signal and the termination signal is continuously transmitted to ECUs being diagnosed until the engine ECU 10 receives all acknowledge signals from the ECUs, or the timeout occurs.

According to the above-described vehicle communication system 1 of the second embodiment, following advantages other than the advantages as described in the first embodiment, can be achieved. In the second embodiment, all ECUs are diagnosed even when a communication status of an ECU triggers the diagnostic procedure. As a result, failures which are not detected in the first embodiment may be detected in the second embodiment. Also, the ECUs performing normal communication can change the load of the communication bus to be lowered by transmitting the start signal. Hence, the test signal suffering from the communication error due to heavy load of the communication bus may be avoided.

In the first diagnostic procedure, the predetermined number of time stamp T (refer to S175) and the timeout period (refer to S150) may be changed depending on respective ECUs being diagnosed. Specifically, the time stamp T is set depending on required accuracy of the system and the timeout period is set to secure required communication rate on the system. In the above-described embodiment, the predetermined number of time stamp T of the ABS/ECU 20 is larger than the number of the air-conditioner ECU 30 and the timeout period of the ABS/ECU 20 is set to be shorter than that of the air-conditioner ECU 30.

(Modification)

As a modification of the above-described embodiments, other communication protocols such as FlexRay (registered trade mark), LIN (Local Interconnect Network) or the like can be adapted to the vehicle communication system 1 of the present invention. Specifically, since the LIN is adapted to use one wire communication line, it is considered that the communication error may not be only caused by a wire breakage. However, an external disturbance such as EMI (electronic magnetic interference) may affect the communication error. In this regard, the vehicle communication system in the present invention can be preferably adapted for such a communication protocol. In the embodiments of the present invention, the diagnostic apparatus is functionally implemented to the engine ECU 10. However, any one of ECUs other than engine ECU, such as ABS/ECU or the air-conditioner ECU may implements the function of the diagnostic apparatus, or a dedicate ECU may be connected to the communication bus and may serve as the diagnostic apparatus. Further, the communication system in the present invention can be configured to use not only a specific communication apparatus but also a plurality of communication apparatuses to operate the diagnostic procedures.

Moreover, in the first diagnostic procedure, when the ECU 10 determines the time stamps T are not matched (S160 NO), the ECU 10 may proceed to S170. As a result, the ECU 10 can proceed to the next step which is transmitting of the test signal without waiting for the time out event. Also, in step 180 at which the E/T is calculated, calculating a certain time stamp T can be excluded. Specifically, when the ECU 10 receives an acknowledge in a fast speed of response that exceeds the theoretical maximum speed, even if the time stamps T are the same value, the ECU 10 cannot determine the communication to be normal. In this case, the time stamp T should be excluded.

Furthermore, the first diagnostic procedure of the first embodiment and the second diagnostic procedure of the second embodiment are triggered when the control data frames have not been received for a predetermined period e.g. 30 msec. In this case, the ECU 10 cannot start the diagnostic procedure if the control data frame occasionally comes with an interval of 29 msec. Assuming true period of transmitting the frames is 10 msec, it is considered that a communication error has possibly occurred on the communication line when the frames occasionally come in such a period which is far from the predetermined period of 30 msec. Therefore, in this situation, diagnostic procedure should be performed to detect possible communication error. In this regard, diagnostic procedure can be triggered by using appropriate received intervals e.g. an interval determined by considering the fluctuations in the intervals of the received frames (i.e. standard deviation of the intervals).

In the embodiments as described above, steps S120/S130/S175 correspond to transmitting means and test signal transmitting means, steps S140 to S160 correspond to first and second determining means, steps S170 and S180 to S190 correspond to diagnosis means, step S220 corresponds to test signal responding means, steps S210, S250, S410 and S620 correspond to extending means, S310 correspond to start signal transmitting means, S420 corresponds to accept signal returning means, S510 corresponds to termination signal transmitting means. Further, the engine ECU 10 corresponds to the diagnostic apparatus, the ABS/ECU 20 and the air-conditioner ECU 30 correspond to the communication apparatus. Also, the control data frame corresponds to the control data signal.

What is claimed is:

1. A diagnostic apparatus being connected to a plurality of communication apparatuses via a communication bus, diagnosing at least one communication apparatus, the diagnostic apparatus comprising:
monitoring means for monitoring a control data signal sent from the communication apparatuses at a predetermined period;
first determining means for determining a communication apparatus to be diagnosed from among the plurality of communication apparatuses based on a result of the monitoring;
transmitting means for transmitting a plurality of test signals to the communication apparatus to be diagnosed when the first determining means determines the communication apparatus, the test signals being uniquely recognizable each other;
receiving means for receiving a response signal sent from the communication apparatus to be diagnosed, the response signal being recognizable as a signal responding to each test signal transmitted by the transmitting means;
second determining means for determining whether or not the receiving means receives the response signal corresponding to each test signal within a predetermined period that limits an elapsed time counted from a time when the test signal is transmitted; and
diagnosis means for diagnosing whether or not a communication error occurs between the diagnostic apparatus and the communication apparatus based on the determining results for respective response signals determined by the second determining means.

2. A diagnostic apparatus being connected to a plurality of communication apparatuses via a communication bus, diagnosing at least one communication apparatus, the diagnostic apparatus comprising:
monitoring means for monitoring a control data signal sent from the communication apparatuses at a predetermined period;
first determining means for determining a communication apparatus to be diagnosed from among the plurality of communication apparatuses based on a result of the monitoring;
start signal transmitting means for transmitting a start signal to the communication apparatuses that periodically send the control data signal when the first determining means determines the communication apparatus, the start signal being used to notify the communication apparatuses about starting of a diagnostic test;
first receiving means for receiving accept signals responding to the start signal, the accept signals being sent from the communication apparatuses;
test signal transmitting means for transmitting a plurality of test signals to the communication apparatuses that send the accept signals, when the first receiving means receives the accept signals, the test signals being uniquely recognizable each other;
second receiving means for receiving a response signal sent from the communication apparatuses, the response signal being recognizable as a signal responding to each test signal transmitted by the transmitting means;
second determining means for determining whether or not the second receiving means receives the response signal corresponding to each test signal within a predetermined period that limits an elapsed time counted from a time when the test signal is transmitted; and
diagnosis means for diagnosing whether or not a communication error occurs between the diagnostic apparatus and the communication apparatus based on the determining results for respective response signals determined by the second determining means.

3. The diagnostic apparatus according to claim 2, wherein the start signal transmitting means is configured to repeatedly transmit the start signal to the communication apparatuses.

4. The diagnostic apparatus according to claim 2, further comprising termination signal transmitting means, wherein the termination signal transmitting means transmits a termination signal to the communication apparatuses that send the accept signals, when the diagnosis means completes the diagnosing.

5. The diagnostic apparatus according to claim 3, further comprising termination signal transmitting means, wherein the termination signal transmitting means transmits a termination signal to the communication apparatuses that send the accept signals, when the diagnosis means completes the diagnosing.

6. The diagnostic apparatus according to claim 1, wherein the transmitting means and the second determining means are configured such that transmitting the test signal by the transmitting means and the determining the response signals by the second determining means are executed sequentially in time for every single test signal.

7. The diagnostic apparatus according to claim 1, wherein the diagnosis means is configured to use all determining results of the response signals determined by the second determining means, when the diagnosis means diagnoses the communication error between the communication apparatuses that receive the test signals and the diagnostic apparatus, the response signals being sent by the communication apparatus.

8. The diagnostic apparatus according to claim 7, wherein the diagnosis means is configured to diagnose the communication error based on a ratio represented by a frequency of failing to receive the response signals within the predetermined period, divided by a frequency of transmitting the test signals transmitted by the transmitting means.

9. A diagnostic system comprising:
a plurality of communication apparatuses that transmit a control data signal at a predetermined period;
a diagnostic apparatus connected to the plurality of communication apparatuses via a communication bus, diagnosing at least one communication apparatus;
monitoring means adapted to the diagnostic apparatus for monitoring the control data signal transmitted from the communication apparatuses;
first determining means adapted to the diagnostic apparatus for determining a communication apparatus to be diagnosed from among the plurality of communication apparatuses based on a result of the monitoring;
test signal transmitting means adapted to the diagnostic apparatus for transmitting a plurality of test signals to the communication apparatus to be diagnosed when the determining means determines the communication apparatus, the test signals being uniquely recognizable each other;
responding means adapted to the communication apparatus for responding to each transmitted test signal by sending a response signal to the diagnostic apparatus when the communication apparatus receives the test signal, the response signal being recognizable as a signal responding to each test signal transmitted by the transmitting means;
second determining means adapted to the diagnostic apparatus for determining whether or not the diagnostic apparatus receives the response signal corresponding to each test signal within a predetermined period that limits an elapsed time counted from a time when the test signal is transmitted; and
diagnosis means adapted to the diagnostic apparatus for diagnosing whether or not a communication error occurs between the diagnostic apparatus and the communication apparatus based on the determining results for respective response signals determined by the second determining means.

10. The diagnostic system according to claim 9, wherein the communication apparatus further comprises extending means for extending the predetermined period used for transmitting the control data signal during a period starting from a time when the communication apparatus receives the test signal to a time when the diagnostic apparatus completes the diagnosing.

11. A diagnostic system comprising:
a plurality of communication apparatuses that transmit a control data signal at a predetermined period;
a diagnostic apparatus connected to the plurality of communication apparatuses via a communication bus, diagnosing at least one communication apparatus;
monitoring means adapted to the diagnostic apparatus for monitoring the control data signal transmitted from the communication apparatuses;
first determining means adapted to the diagnostic apparatus for determining a communication apparatus to be diagnosed from among the plurality of communication apparatuses based on a result of the monitoring;
start signal transmitting means adapted to the diagnostic apparatus for transmitting a start signal to the communication apparatuses that periodically transmit the control data signal when the first determining means determines the communication apparatus, the start signal being used to notify the communication apparatuses about starting of a diagnostic test;
extending means adapted to the communication apparatus for extending the predetermined period used for transmitting the control data signal when the communication apparatus once receives the start signal;
accept signal returning means adapted to the communication apparatus for returning an accept signal to the diagnostic apparatus when the communication apparatus receives the start signal transmitted by the start signal transmitting means;
test signal transmitting means adapted to the diagnostic apparatus for transmitting a plurality of test signals to the communication apparatuses that transmit the accept signals, when the diagnostic apparatus receives the accept signal, the test signals being uniquely recognizable each other;
test signal responding means adapted to the communication apparatus for responding to each transmitted test signal by sending a response signal to the diagnostic apparatus when the communication apparatus receives the test signal, the response signal being recognizable as a signal responding to each test signal transmitted by the transmitting means;
second determining means for determining whether or not the diagnostic apparatus receives the response signal corresponding to each test signal within a predetermined period that limits an elapsed time counted from a time when the test signal is transmitted; and
diagnosis means for diagnosing whether or not a communication error occurs between the diagnostic apparatus and the communication apparatus based on the determining results for respective response signals determined by the second determining means.

12. The diagnostic system according to claim 11, further comprising termination signal transmitting means, wherein the termination signal transmitting means transmits a termination signal to the communication apparatuses that returned the accept signals, when the diagnosis means completes the diagnosing, and the extending means reset the extended period to the predetermined period when the diagnosis means completes the diagnosing.

13. The diagnostic system according to claim 11, wherein the start signal transmitting means is configured to repeatedly transmit the start signal to the communication apparatuses.

14. The diagnostic system according to claim 12, wherein the start signal transmitting means is configured to repeatedly transmit the start signal to the communication apparatuses.

15. The diagnostic system according to claim 9, wherein the test signal transmitting means and the second determining means are configured such that transmitting the test signal by the test signal transmitting means and the determining the response signals by the second determining means are executed sequentially in time for every single test signal.

16. The diagnostic system according to claim 9, wherein the diagnosis means is configured to use all determining results of the response signals determined by the second determining means, when the diagnosis means diagnoses the communication error between the communication apparatuses that receive the test signals and the diagnostic apparatus, the response signals being sent by the communication apparatus.

17. The diagnostic system according to claim 16, wherein the diagnosis means is configured to diagnose the communication error based on a ratio represented by a frequency of failing to receive the response signals within the predetermined period, divided by a frequency of transmitting the test signals transmitted by the test signal transmitting means.

18. A diagnostic method executed on a diagnostic apparatus being connected to a plurality of communication apparatuses via a communication bus, diagnosing at least one communication apparatus, the method comprising steps of:
monitoring a control data signal sent from the communication apparatuses at a predetermined period;
determining a communication apparatus to be diagnosed from among the plurality of communication apparatuses based on a result of the monitoring;
transmitting a plurality of test signals to the communication apparatus to be diagnosed when the communication apparatus is determined;
receiving a response signal sent from the communication apparatus to be diagnosed;
determining whether or not the diagnostic apparatus receives the response signal corresponding to each test signal within a predetermined period that limits an elapsed time counted from a time when the test signal is transmitted; and
diagnosing whether or not a communication error occurs between the diagnostic apparatus and the communication apparatus based on the determining results for respective response signals.

19. A diagnostic method executed on a diagnostic apparatus being connected to a plurality of communication apparatuses via a communication bus, diagnosing at least one communication apparatus, the method comprising steps of:
monitoring a control data signal sent from the communication apparatuses at a predetermined period;
determining a communication apparatus to be diagnosed from among the plurality of communication apparatuses based on a result of the monitoring;
transmitting a start signal to the communication apparatuses that periodically send the control data signal when the communication apparatus is determined;
receiving accept signals responding to the start signal, the accept signals being sent from the communication apparatuses;
transmitting a plurality of test signals to the communication apparatuses that send the accept signals, when the diagnostic apparatus receives the accept signals;
receiving a response signal sent from the communication apparatuses, the response signal being recognizable as a signal responding to each test signal;
determining whether or not the diagnostic apparatus receives the response signal corresponding to each test signal within a predetermined period that limits an elapsed time counted from a time when the test signal is transmitted; and
diagnosing whether or not a communication error occurs between the diagnostic apparatus and the communication apparatus based on the determining results for respective response signals determined by the second determining means.
